(19) United States
(12) Patent Application Publication
(10) Pub. No.: US 2015/0356797 A1
(43) Pub. Date: Dec. 10, 2015

(54) VIRTUAL KEY FOB WITH TRANSFERABLE USER DATA PROFILE

(71) Applicant: INTERNATIONAL BUSINESS MACHINES CORPORATION, Armonk, NY (US)

(72) Inventors: Gregory E. McBride, Vail, AZ (US); David C. Reed, Tucson, AZ (US); Max D. Smith, Tucson, AZ (US)

(73) Assignee: INTERNATIONAL BUSINESS MACHINES CORPORATION, Armonk, NY (US)

(21) Appl. No.: 14/296,569

(22) Filed: Jun. 5, 2014

(51) Int. Cl. G07C 9/00

(52) U.S. Cl. CPC G07C 9/00119; G07C 9/00309; G07C 2009/00769

(57) ABSTRACT

A method for controlling various aspects of a vehicle includes registering a first mobile general-purpose processing device, such as a smart phone, with a vehicle. The method further authorizes the first mobile general-purpose processing device to be used as a key fob for controlling the vehicle. The method generates a user profile associated with a user of the vehicle. The user profile is stored on one or more of the first general-purpose processing device and the vehicle and contains information related to controlling the vehicle. The method enables at least part of the user profile to be downloaded to a second mobile general-purpose processing device to enable the second mobile general-purpose processing device to be used as a key fob for controlling the vehicle. A corresponding system and computer program product are also disclosed.

### BACKGROUND

1. Field of the Invention

This invention relates to systems and methods for accessing and controlling vehicles.

2. Background of the Invention

Most modern vehicles include a key fob or other device to wirelessly transmit control signals to a vehicle in order to control various features, such as lock or unlock doors, open a trunk or rear hatch, start or turn off the engine, turn on a security light, etc. Systems have also been introduced to enable automatic changes in vehicle preference settings based on which key fob is used to operate a vehicle. Although varying in design, most key fobs provide buttons with images or words describing associated functions. Pressing these buttons may cause associated control signals to be transmitted to the vehicle. Control signals transmitted from the key fob may be coded in such a manner that, although they may be decoded and understood by the vehicle, they may not be recorded or resent by a third party. Key fobs of the type described above typically have a limited range, and provide a certain level of convenience to a user.

Mobile general-purpose processing devices, such as smart phones, are increasingly common in today's marketplace. Smart phones, in particular, have become increasingly powerful both in terms of their processing power and breadth of utility. A wide variety of applications have been introduced that greatly expand the functionality of the smart phone. This has allowed smart phones to at least partially displace many traditional technologies, such as credit cards, calendaring systems, books, music players, calculators, dedicated cameras, conventional computers systems, and the like. In some cases, smart phones are equipped to communicate with nearby devices using wireless technologies such as near field communication (NFC), Bluetooth®, WIFI, or other wireless communication technologies.

In view of the foregoing, what are needed are systems and methods to enable mobile general-purpose processing devices, such as smart phones, to act as virtual keys to access and control various aspects of a vehicle. Further needed are systems and methods for transferring control between mobile general-purpose processing devices.

### SUMMARY

The invention has been developed in response to the present state of the art and, in particular, in response to the problems and needs in the art that have not yet been fully solved by currently available systems and methods. Accordingly, systems and methods are disclosed to more optimally access and control various aspects of a vehicle using devices such as smart phones. The features and advantages of the invention will become more fully apparent from the following description and appended claims, or may be learned by practice of the invention as set forth hereinafter.

Consistent with the foregoing, a method for controlling various aspects of a vehicle is disclosed. In one embodiment, such a method includes registering a first mobile general-purpose processing device, such as a smart phone, with a vehicle. The method further authorizes the first mobile general-purpose processing device to be used as a key fob for controlling the vehicle. The method generates a user profile associated with a user of the vehicle. The user profile is stored on one or more of the first general-purpose processing device and the vehicle and contains information related to controlling the vehicle. The method enables at least part of the user profile to be downloaded to a second mobile general-purpose processing device to enable the second mobile general-purpose processing device to be used as a key fob for controlling the vehicle. A corresponding computer program product is also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level diagram showing use of a general-purpose processing device as a virtual key to control various aspects of a vehicle;

FIG. 2 is a high-level diagram showing establishment of user profiles for various users of the vehicle;

FIG. 3 is a high-level diagram showing upload and download of user profiles associated with users of the vehicle;

FIG. 4A shows one technique for receiving authentication information from a user;

FIG. 4B shows another technique for receiving authentication information from a user; and

FIG. 5 shows modules for providing various features and functions of a system in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

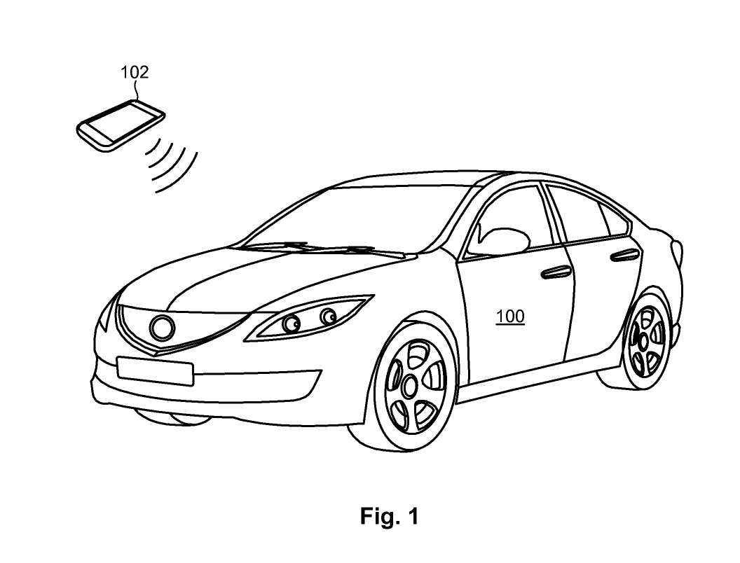

Referring to FIG. 1, as previously mentioned, most modern vehicles include a key fob or other device to wirelessly transmit control signals to a vehicle in order to control various features, such as lock or unlock doors, open a trunk or rear hatch, start the engine, turn on a security light, etc., without having to insert a key. In some cases, key fobs may also enable automatic changes in vehicle preference settings based on which key fob is used to operate a vehicle. For example, when Driver A possessing Key Fob A enters or nears a vehicle, the vehicle may automatically adjust a seat, mirrors, steering wheel, radio settings, and/or climate control settings for Driver A. Similarly, when Driver B possessing Key Fob B enters or nears the same vehicle, the vehicle may automatically adjust the seat, mirrors, steering wheel, radio settings, and/or climate control settings for Driver B.

As also previously explained, mobile general-purpose processing devices, such as smart phones, are increasingly common in today's marketplace. Smart phones, in particular, have become increasingly powerful both in terms of their processing power and breadth of utility. A wide variety of applications have been introduced that greatly expand the functionality of the smart phone. This has allowed smart phones to at least partially displace many traditional technologies, such as credit cards, calendaring systems, books, music players, calculators, dedicated cameras, conventional computers systems, and the like. In some cases, smart phones may be equipped to communicate with nearby devices using near field communication (NFC), Bluetooth®, WIFI, or other wireless communication technologies.

In view of the foregoing, it would be advance in the art to enable a general-purpose processing device 102, such as a smart phone, to act as a virtual key fob for controlling various aspects of a vehicle 100. Such a virtual key fob may be used in place of a conventional key fob to reduce the number of items a user must carry. The virtual key fob may also be advantageous in that updates, upgrades, or the like could be downloaded directly to a general-purpose processing device 102 by way of a network such as a WIFI network or a cellular telephone network. The general-purpose processing device 102 may also provide an improved user experience when accessing and controlling a vehicle 100. For example, a user interface implemented on a touch screen of a smart phone or other device may provide additional interactivity, buttons 110, controls, options, and/or feedback than might otherwise be possible using a conventional key fob.

In certain embodiments, the general-purpose processing device 102 may use a native wireless communication technology to communicate with the vehicle 100. For example, the general-purpose processing device 102 may use Bluetooth®, WIFI, or near field communication (NFC) to communicate with the vehicle 100. In other embodiments, the general-purpose processing device 102 may be configured to transmit at a frequency allocated to conventional remote keyless systems (RKS). Such remote keyless systems typically include a short-range radio transmitter that must be within a certain range, usually 5-20 meters (15-60 ft), of the vehicle 100 to work. When a button is pushed, a coded RF signal is sent to a receiver unit in the car, which locks or unlocks the door or performs other functions. Most remote keyless systems operate at a frequency of 315 MHz for North America-made cars and at 433.92 MHz for European, Japanese and Asian cars. In certain embodiments, such functionality may be incorporated into a general-purpose processing device 102 either as standard equipment or as an expansion component.

Various different steps may be taken to get the general-purpose processing device 102 to function as a virtual key fob. In certain embodiments, for example, a user may initially register the general-purpose processing device 102 with the vehicle 100. For example, when using Bluetooth®, a user may initially register the general-purpose processing device 102 with the vehicle 100 through the Bluetooth® pairing process. During the pairing process, a secure relationship may be established between the general-purpose processing device 102 and the vehicle 100. After the initial pairing process, the general-purpose processing device 102 and the vehicle 100 may automatically establish a connection when the general-purpose processing device 102 comes within a specified distance of the vehicle 100. In certain embodiments, a user's phone number associated with the general-purpose processing device 102 (in the case of a smart phone) may be registered with the vehicle 100 and act as a security token when communicating with the vehicle 100. Other unique identifiers may also be used to register the general-purpose processing device 102 with the vehicle 100 and/or act as a security token.

Once the general-purpose processing device 102 has been registered with the vehicle 100, the user may be provided an option to make the general-purpose processing device 102 an authorized key fob for use with the vehicle 100. Once authorized, the user may no longer need to carry their conventional key fob to lock/unlock the vehicle 100 or perform other functions associated with the vehicle 100. Use of the general-purpose processing device 102 may suffice. In certain embodiments, the vehicle 100 may constantly monitor for the general-purpose processing device 102 to come within communication range of the vehicle 100 and/or awaken when a door handle or other part of the vehicle 100 is activated.

In certain embodiments, an application or program on the general-purpose processing device 102 may enable the general-purpose processing device 102 to provide substantially the same functions or capabilities as the conventional key fob. For example, buttons or controls on a conventional key fob may be mimicked by virtual buttons or controls on the general-purpose processing device 102. In other cases, proximity of the general-purpose processing device 102 to the vehicle 100 may trigger actions (e.g., locking/unlocking) or cause automatic changes in vehicle preference settings for a user associated with the virtual key fob. The virtual key fob may also cause feedback mechanisms (e.g., vehicle chirping, vehicle lights, etc.) to behave in much the same way they would with a conventional key fob. Other types of feedback or vehicle status information (such as also might be viewable on displays inside the vehicle) may be displayed on the general-purpose processing device for viewing by a user.

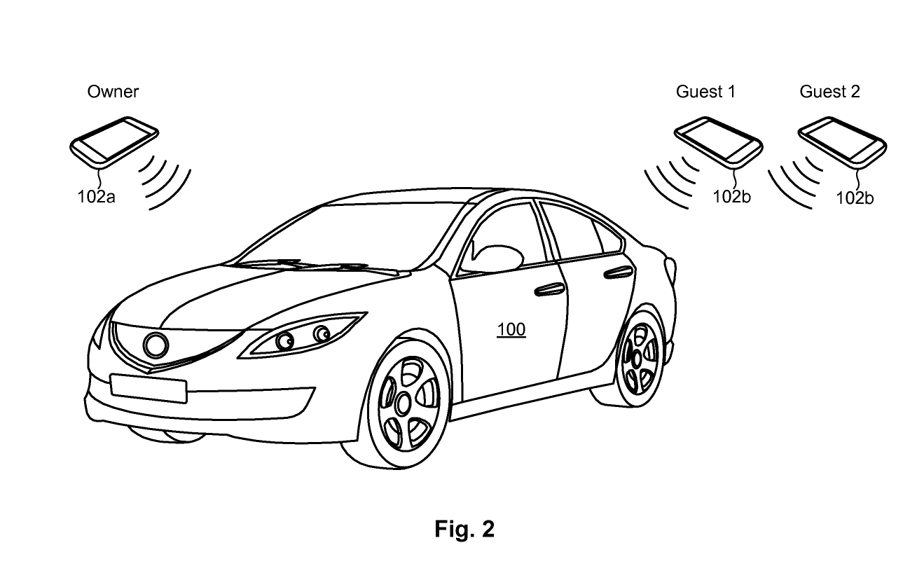

Referring to FIG. 2, in certain embodiments, different user profiles may be established for different users of the vehicle 100. For example, in certain embodiments, an initial general-purpose processing device 102 registered with the vehicle 100 may be considered an “owner” and any subsequent general-purpose processing devices 102 registered with the vehicle 100 may be considered “guests.” In certain embodiments, the owner device 102a may act as a system administrator with a superior level of authority to establish and modify system settings as well as set or adjust the authority and settings of other guest devices 102b.

In certain embodiments, any general-purpose processing device 102b registered with the vehicle 100 after the owner device 102a may require the owner device 102a to be in communication range of the vehicle 100 and authorize the general-purpose processing device 102b to act as a virtual key fob for the vehicle 100. Once authorization is granted, the guest device 102b may also act as a key fob for the vehicle 100, albeit with a lesser level of authority than the owner device 102a, unless such key fob is granted a level of authority that is commensurate with the owner device. In certain embodiments, the guest device may be prevented from authorizing other general-purpose processing devices for use as key fobs, or changing restrictions or settings for other devices.

As alluded to above, in certain embodiments, restrictions may be placed on selected devices 102b configured to function as key fobs. Such restrictions, for example, may limit the ways in which guests can use the vehicle 100. For example, many vehicles are equipped with electronic speed limiters. If a parent has authorized a child's device 102b to act as a key fob for the vehicle 100, the parent may set restrictions that limit the speed of the vehicle 100 when it is used by the child. Similarly, the parent may set restrictions with respect to how far the vehicle 100 may travel away from a home location, the times and/or days the vehicle 100 may be used, the amount the vehicle 100 may be accelerated, the volume of the radio, or the like.

In certain embodiments, setting restrictions may also include establishing notifications for various events associated with the vehicle. The notifications may come in the form of a text, email, phone call, or other message to an “owner” of the vehicle 100. For example, a notification may be sent when the vehicle 100 is locked/unlocked, started or turned off, exceeds a specified speed, accelerates above a specified amount, brakes faster than a specified amount, drives outside a specified geographical area, or the like. In other cases, a notification may be sent when an unregistered device 102 is used to access or control the vehicle 100 (such as a borrowed device 102 used to gain temporary access to the vehicle 100), as will be explained in more detail hereafter. Other restrictions and notifications are also possible and within the scope of the invention. Restrictions and notifications may vary for different user profiles. For example, restrictions and notification may be greater for some guest profiles and relaxed or removed for other guest profiles or the owner profile.

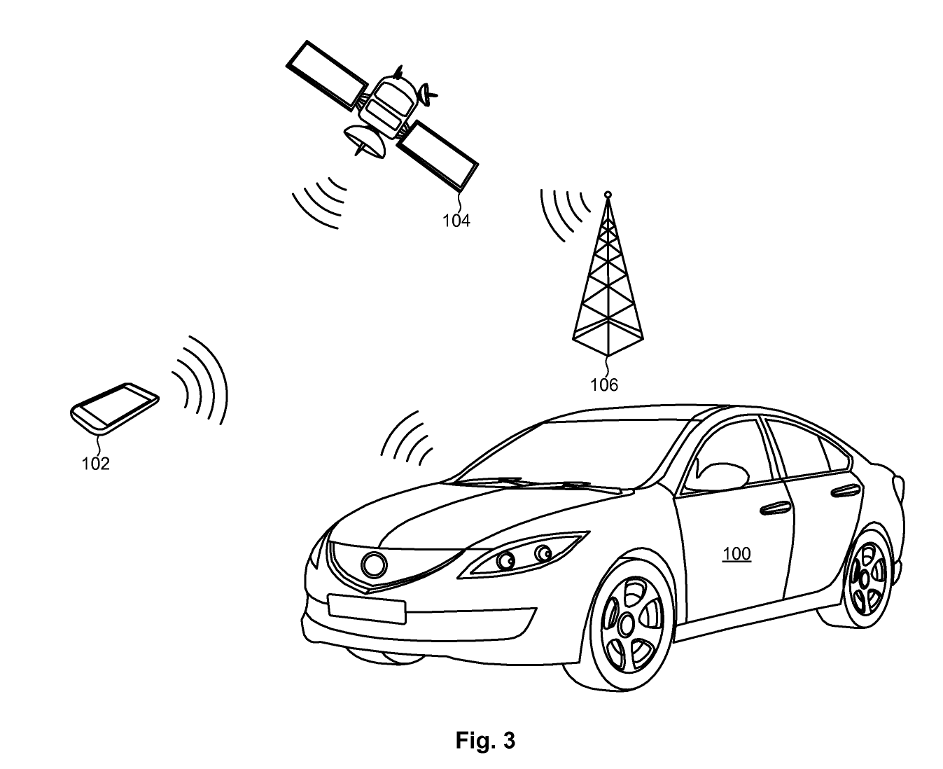

Referring to FIG. 3, the owner and guest user profiles may be saved and maintained in various locations. In some embodiments, the profiles are saved on the vehicle 100 and the general-purpose processing devices 102 with which they are associated. In other embodiments, the owner device 102a may store a profile not only for the owner device 102a, but also for all guest devices 102b. This may enable the owner device 102a to establish or modify settings not only for the owner device 102a, but also guest devices 102b.

In certain embodiments, the user profiles are also stored at a remote location, such as a server in the “cloud.” For example, the user profiles may be uploaded from the general-purpose processing devices 102 and/or vehicle 100 to a remote server over WIFI, a cellular network, or the like (such as by communicating with a satellite 104, tower 106, or access point 106). In the event, a user's general-purpose processing device 102 is lost, stolen, broken, or simply dead (due to discharged batteries, etc.), the user profile may be accessed from another general-purpose processing device 102. For example, a user's profile may be downloaded to a new general-purpose processing device 102 for use as a virtual key fob as previously described.

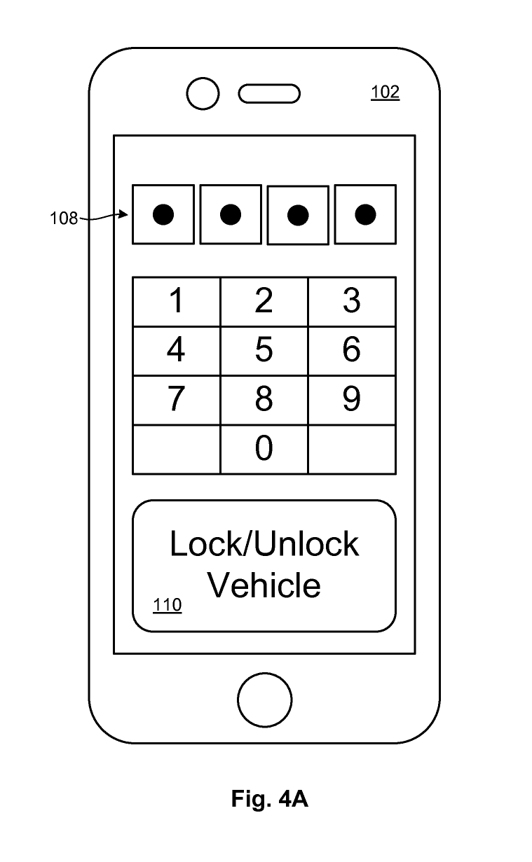

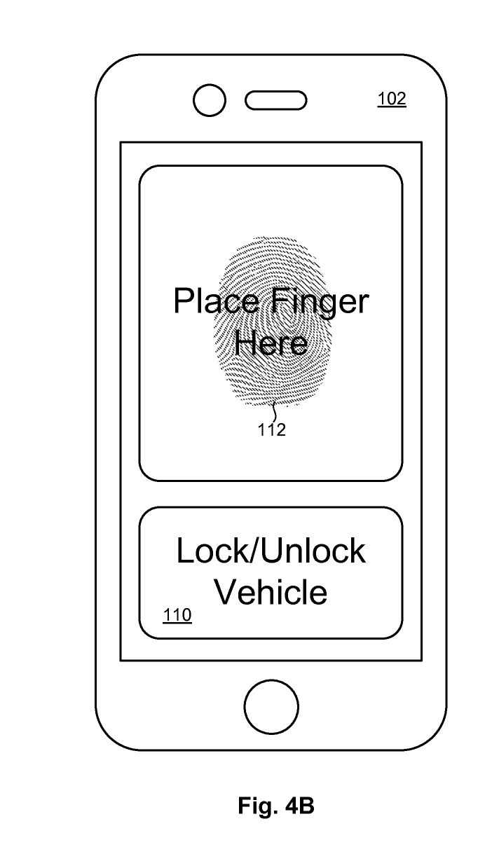

In certain embodiments, when a user profile is downloaded to a general-purpose processing device 102 that is not registered with a vehicle 100, the user must be authenticated before the general-purpose processing device 102 will be registered and/or authorized to act as a virtual key fob. In certain embodiments, a user may be required to enter a correct password 108 or biometric information 112 such as a fingerprint 112 before the general-purpose processing device 102 will be registered and/or authorized to act as a virtual key fob. FIGS. 4A and 4B show two different exemplary user interfaces for authenticating a user on a general-purpose processing device 102, one using a password 108 and the other a fingerprint 112.

Thus, in certain embodiments, user profiles may store (and potentially encrypt) authentication information such as passwords 108 or biometric information 112. This will ensure that a vehicle 100 cannot be accessed or used in an unauthorized manner. For example, if a user's smart phone is lost and the user's profile is temporarily downloaded onto a different smart phone, the user may be required to enter authentication to ensure that unauthorized users are not attempting to access or control the vehicle 100. In certain embodiments, user authentication may be required not only on unregistered devices, but also on registered devices 102 in order to periodically authenticate users and prevent unauthorized use or control of the vehicle 100.

In certain embodiments, authenticating a user may provide only temporary authorization to use or control a vehicle 100. For example, correctly entering authentication information may only authorize a single use (or other number of uses) of the vehicle 100. In other embodiments, correctly entering authentication information may only authorize use of the vehicle 100 for a selected period of time. In certain embodiments, the numbers of uses or time period may be reset by reentering the authentication information. Such a feature may not only enable an authorized user to use and control the vehicle 100 from a borrowed general-purpose processing device 102, but also potentially allow the vehicle 100 to be loaned to a friend or other person on a temporary basis. For example, a parent could grant a child temporary access to a vehicle 100, only to have the privileges withdrawn at a later time. This could be accomplished by either changing a password 108 or other authentication information needed to use the vehicle 100, or providing a temporary password 108 or other authentication information that expires after a selected amount of time or number of uses.

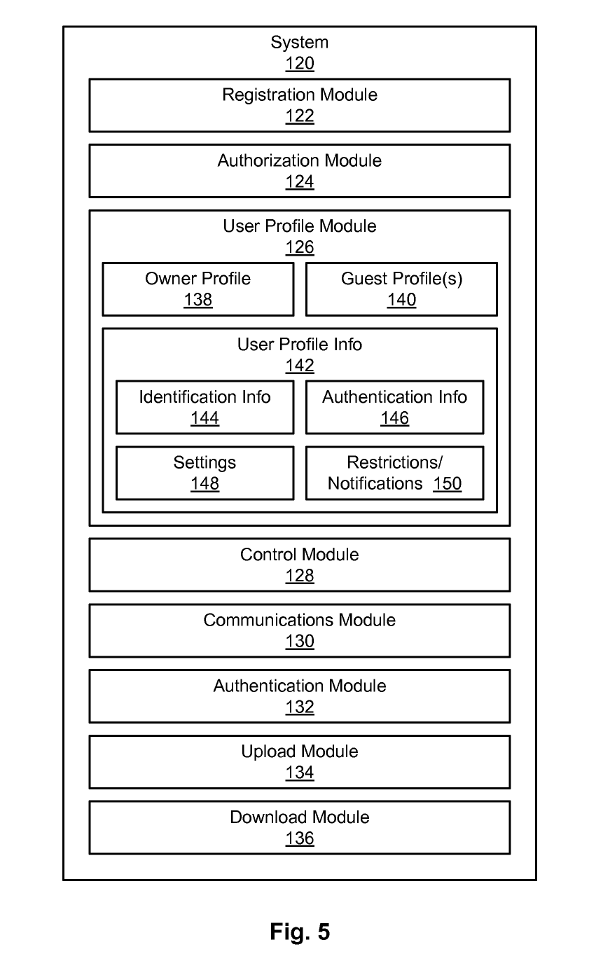

Referring to FIG. 5, one embodiment of a system 120 in accordance with the invention is illustrated. As shown, the system 120 includes one or more modules that provide various features and functions. These modules may be implemented in hardware, software or firmware executable on hardware, or a combination thereof. The modules are presented only by way of example and are not intended to be limiting. Indeed, alternative embodiments may include additional modules or fewer modules as needed, or the modules may be organized differently. Furthermore, in some embodiments, the functionality of some modules may be broken into multiple modules or, conversely, the functionality of several modules may be combined into a single or fewer modules. It should also be recognized that the functionality of the modules may be distributed across multiple devices. For example, a module may have some functionality implemented in a general-purpose processing device 102, a vehicle 100, a cloud-based server, or a combination thereof. For example, the control module 128 may include functionality in a general-purpose processing device 102 to generate a command and functionality in a vehicle 100 to execute the command. Thus, modules may be implemented in a single device or potentially distributed across multiple devices, depending on the module and the embodiment involved.

As shown, in certain embodiments, a system 120 in accordance with the invention includes one or more of a registration module 122, authorization module 124, user profile module 126, control module 128, communications module 130, authentication module 132, upload module 134, and download module 136.

As shown, a registration module 122 may be configured to initially register a general-purpose processing device 102 with a vehicle 100. For example, if the general-purpose processing device 102 communicates with the vehicle 100 using the Bluetooth® protocol, the registration module 122 may pair the general-purpose processing device 102 with the vehicle 100 using the Bluetooth® pairing process. Once registered, an authorization module 124 may enable a user to authorize the general-purpose processing device 102 for use as a virtual key fob to access and control the vehicle 100.

A user profile module 126 may be used to establish user profiles for different users of the vehicle 100. An owner profile 138 may be generated for an initial general-purpose processing device registered 102 with the vehicle 100. The owner may act as a system administrator with authority to establish and modify system settings as well as set or adjust the authority or permissions of others. Guest profiles 140 may be generated for any subsequent general-purpose processing devices 102 registered with the vehicle 100.

The user profiles 138, 140 may contain various types of information 142. For example, the user profiles 138, 140 may contain one or more of identification information 144, authentication information 146, settings 148, and restriction and/or notification information 150. Identification information 144, such as a phone number, may be used to uniquely identify a user. In certain embodiments, this identification information 144 may be used as a security token for communications between a general-purpose processing device 102 and a vehicle 100.

The user profiles 138, 140 may also include authentication information 146, such as a password 108 or biometric information 112, used to authenticate a user associated with a user profile 138, 140. In certain embodiments, the authentication information 146 may be used to authenticate a user if the user profile is transferred to a new or borrowed device. In certain cases, entering correct authentication information 146 may only provide temporary authorization to use or control a vehicle 100.

The user profiles 138, 140 may also contain settings 148 for users of a vehicle 100. Such settings 148 may include settings associated with seats, mirrors, a steering wheel, a radio, climate control, or the like. In certain embodiments, some or all of the setting 148 may be automatically implemented in the vehicle 100 when the associated general-purpose processing device 102 nears or is inside the vehicle 100. Thus, functionality may be incorporated into the general-purpose processing device 102 and/or vehicle 100 to detect when the general-purpose processing device 102 is near or inside the vehicle 100.

The user profiles 138, 140 may also contain restriction and/or notification information 150. As previously explained, restrictions 150 may limit the ways in which guests can use the vehicle 100, such as how the far a vehicle 100 may travel away from a home location, times and/or days a vehicle 100 may be used, an amount the vehicle 100 may be accelerated, a volume of the radio, or the like. Notifications 150 may also be established for events associated with the vehicle 100. Such notification 150 may come in the form of a text, email, phone call, or other message sent to an “owner” of the vehicle 100 or other person. For example, a notification 150 may be sent when the vehicle 100 is locked/unlocked, started or turned off, exceeds a specified speed, accelerates above a specified amount, brakes faster than a specified amount, drives outside a specified geographical area, or the like. A notification 150 may also be sent when an unregistered device 102 is used to access or control the vehicle 100, such as in cases when an unregistered device 102 is used for unauthorized access or a user wishes to monitor control by unregistered devices 102.

Once a general-purpose processing device 102 is registered with a vehicle 100 and the general-purpose processing device is authorized to act as a key fob for the vehicle 100, a control module 128 may enable control of the vehicle 100. For example, the control module 128 may include functionality to send commands to the vehicle 100 (lock, unlock, start, turn off commands, etc.) as well as functionality to execute the commands at the vehicle 100. The control module 128 may also be configured to implement settings 148 (such as when the virtual key fob is near or in the vehicle 100) as well as the restrictions 150 and notifications 150 set forth in the user profiles 138, 140.

A communications module 130 may be configured to enable communications between the general-purpose processing device 102 and vehicle 100 using an appropriate communications protocol. For example, the communications module 130 may enable communications using Bluetooth®, WIFI, or near field communication (NFC) protocols. In other embodiments, the communications module 130 may enable communications at a frequency allocated to conventional remote keyless systems (RKS).

An authentication module 132 may be used to authenticate a user, such as when a user profile 138, 140 is downloaded to a general-purpose processing device 102 that is not registered with a vehicle 100. In other embodiments, the authentication module 132 may periodically authenticate users even on registered devices 102, such as to ensure that a registered device 102 is not being used by an unauthorized individual. The authentication module 132 may authenticate a user by any known means, such as by accepting and verifying a password or biometric information.

As previously discussed, in certain embodiments, the user profiles 138, 140 may be stored at a remote location, such as a server in the “cloud.” This will allow the user profiles 138, 140 to be accessed in the event a general-purpose processing device is lost, stolen, broken, or dead. An upload module 134 may enable the user profiles 138, 140 to be uploaded to the remote location from the general-purpose processing device or vehicle 100. Similarly, a download module 136 may enable the user profiles 138, 140 to be downloaded from the remote location to a general-purpose processing device 102 or vehicle 100. In certain embodiments, where user profiles 138, 140 are stored at the vehicle 100, the download module 136 may enable user profiles 138, 140 to be downloaded directly from the vehicle 100 to a general-purpose processing device 102.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for controlling various aspects of a vehicle, the method comprising:
registering a first mobile general-purpose processing device with a vehicle;
authorizing the first mobile general-purpose processing device to be used as a key fob for controlling the vehicle;
generating a user profile associated with a user of the vehicle, the user profile stored on at least one of the first general-purpose processing device and the vehicle, the user profile containing information needed to control the vehicle;
enabling at least part of the user profile to be downloaded to a second mobile general-purpose processing device, thereby enabling the second mobile general-purpose processing device to be used as a key fob for controlling the vehicle.

2. The method of claim 1, wherein the user profile is downloaded from a server in the cloud.

3. The method of claim 1, wherein the user profile is downloaded from the vehicle.

4. The method of claim 1, wherein the user profile is downloaded from the first mobile general-purpose processing device.

5. The method of claim 1, wherein the user profile contains authentication information needed to authenticate the user prior to enabling control of the vehicle.

6. The method of claim 5, wherein the authentication information comprises password authentication information.

7. The method of claim 5, wherein the authentication information comprises biometric authentication information.

8. The method of claim 5, wherein authenticating the user enables temporary control of the vehicle.

9. The method of claim 8, wherein the temporary control enables control for a selected number of uses.

10. The method of claim 8, wherein the temporary control enables control for a selected amount of time.

11. A computer program product for controlling various aspects of a vehicle, the computer program product comprising a computer-readable storage medium having computer-usable program code embodied therein, the computer-usable program code comprising:
computer-usable program code to register a first mobile general-purpose processing device with a vehicle;
computer-usable program code to authorize the first mobile general-purpose processing device to be used as a key fob for controlling the vehicle;
computer-usable program code to generate a user profile associated with the first general-purpose processing device, the user profile containing information needed to control the vehicle;
computer-usable program code to enable the user profile to be downloaded from the remote location to a second mobile general-purpose processing device, thereby enabling the second mobile general-purpose processing device to be used as a key fob for controlling the vehicle.

12. The computer program product of claim 11, wherein the user profile is downloaded from a server in the cloud.

13. The computer program product of claim 11, wherein the user profile is downloaded from the vehicle.

14. The computer program product of claim 11, wherein the user profile is downloaded from the first mobile general-purpose processing device.

15. The computer program product of claim 11, wherein the user profile contains authentication information needed to authenticate the user prior to enabling control of the vehicle.

16. The computer program product of claim 15, wherein the authentication information comprises password authentication information.

17. The computer program product of claim 15, wherein the authentication information comprises biometric authentication information.

18. The computer program product of claim 15, wherein authenticating the user comprises enabling temporary control of the vehicle.

19. The computer program product of claim 18, wherein the temporary control enables control for a selected number of uses.

20. The computer program product of claim 18, wherein the temporary control enables control for a selected amount of time.
